(19) United States
(12) Patent Application Publication
(10) Pub. No.: US 2009/0051292 A1
(43) Pub. Date: Feb. 26, 2009

(54) Fluorescent lamp apparatus

(76) Inventor: Si Chung Noh, Gyeonggi-do (KR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/229,353

(22) Filed: Aug. 21, 2008

(30) Foreign Application Priority Data
Aug. 21, 2007 (KR) 10-2007-0084205

(51) Int. Cl. H01J 65/00

(52) U.S. Cl. 313/607

(57) ABSTRACT

Disclosed herein is a fluorescent lamp apparatus. The fluorescent lamp apparatus includes a main lamp tube emitting light, a subsidiary lamp tube disposed in communication with the main lamp tube, an external electrode provided to the subsidiary lamp tube, a connection terminal contacting the external electrode such that electric power is applied to the external electrode through the connection terminal, and an insulation cap receiving the connection terminal. The fluorescent lamp apparatus includes the external electrode exposed to the outside, so that installation and separation of the fluorescent lamp can be conveniently achieved.

### CROSS REFERENCE TO RELATED APPLICATIONS

This application claims the benefit of Korean Patent Application No. 10-2007-0084205 filed on Aug. 21, 2007, which is incorporated by reference herein for any purpose.

### FIELD OF THE INVENTION

The present invention relates to a fluorescent lamp apparatus, and more particularly, to a fluorescent lamp apparatus that has external electrodes disposed to permit convenient installation and separation of a fluorescent lamp.

### DESCRIPTION OF THE RELATED ART

Generally, fluorescent lamps are classified into cold cathode fluorescent lamps (CCFLs) and external electrode fluorescent lamps (EEFLs).

In a CCFL, cylindrical nickel electrodes are disposed on inner walls of opposite ends of a glass tube to generate light via voltage discharge through the nickel electrodes. In the CCFL, it is very difficult to locate the nickel electrodes to the inner walls of the opposite ends of the glass tube and it is necessary to have a light guide plate and a diffuser. Further, the CCFL is vulnerable to damage to junction portions between the nickel electrode and the glass tube, which reduces service life of the fluorescent lamp.

In the EEFL, external electrodes are located on opposite ends of a sealed glass tube and generate an electric field via capacitive coupling with a wall of the glass tube to generate light via plasma discharge.

The EEFL has a service life about five times that of general fluorescent lamps and has advantages of less power consumption and uniform brightness, which have resulted in an increasing demand thereof.

FIG. 1 is a schematic view of the overall configuration of a conventional EEFL.

Referring to FIG. 1, a plurality of lamps 10 are connected in parallel to a single inverter 40 through a connection module 20 and a connection wire 30.

Here, unlike a general fluorescent lamp or a similar lighting fixture, each of the lamps 10 has an electrode which is made of a metal paste and is disposed at either outer end of a glass tube to be connected to an output terminal of the inverter 40 through the connection module 20 and connection wire 30.

With this configuration, electric power is supplied to the lamp through the connection wire 30 and connection module 20 via the inverter 40, so that the electric field is generated inside the lamp 10 to emit light via plasma discharge.

In such a conventional fluorescent lamp, a terminal is provided to an end of a main tube which emits light, and is connected to the connection module. Therefore, when a plurality of main tubes is connected in series, the terminals and the connection modules are disposed between the respective main tubes, thereby causing dark areas between the tubes.

Further, since the connection module is disposed to hold the end of the main tube, the connection module can interfere with attachment and detachment of the main tubes, so that the conventional fluorescent lamp suffers difficulties in installation and replacement of the main tubes. Therefore, there is a need of an improved fluorescent lamp apparatus which overcomes such problems of the conventional fluorescent lamps.

### SUMMARY OF THE INVENTION

The present invention is conceived to solve the problems of the conventional techniques as described above, and it is an aspect of the present invention, to provide a fluorescent lamp apparatus which has an improved structure for detachably mounting main tubes to allow consecutive arrangement of light emitting parts of the main tubes while ensuring easy installation and replacement of the main tubes.

In accordance with an aspect of the present invention, a fluorescent lamp apparatus includes a main lamp tube emitting light; a subsidiary lamp tube disposed in communication with the main lamp tube; an external electrode provided to the subsidiary lamp tube; a connection terminal contacting the external electrode such that electric power is applied to the external electrode through the connection terminal; and an insulation cap receiving the connection terminal.

The connection terminal may include a first connection terminal contacting only a first power supply and a second connection terminal contacting only a second power supply.

Each of the first and second connection terminals may include a close contact part contacting the external electrode; an extension part extending from the close contact part; and a contact part contacting only the first and second power supplies.

The insulation cap may include an insertion part receiving the first and second connection terminals; and a through-hole formed on one side of the insertion part such that the extension part is fitted into the through-hole.

The fluorescent lamp apparatus may further include a base on which the insulation cap is detachably mounted. Here, the base has the first and second power supplies.

The base may include a seat on which the insulation cap is detachably mounted, a holding part holding the first and second power supplies, and a separation preventing part maintaining contact between the connection terminal and the first and second power supplies, the separation preventing part including a resilient depression formed on either side of the base and a latch protrusion formed on the insulation cap.

The subsidiary lamp tube may be disposed at a lateral side of the main lamp tube. The subsidiary lamp tube may be disposed in parallel with the main lamp tube. Here, the subsidiary lamp tube may be disposed at an angle with respect to an imaginary line extending from the main lamp tube.

### BRIEF DESCRIPTION OF THE DRAWINGS

The above and other features and advantages of the present invention will become apparent from the following description of preferred embodiments given in conjunction with the accompanying drawings, in which:

FIG. 1 is a schematic view of the overall configuration of a conventional EEFL;

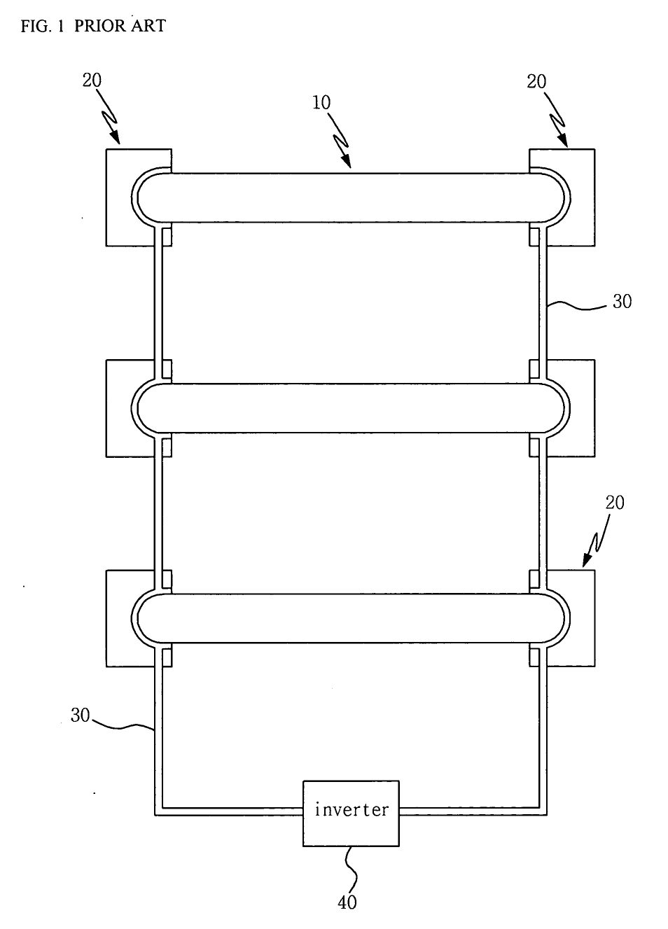

FIG. 2 is an exploded perspective view of a fluorescent lamp apparatus according to one embodiment of the present invention;

FIG. 3 is an exploded perspective view of an insulation cap of the fluorescent lamp apparatus according to the embodiment of the present invention;

FIG. 4 is an exploded perspective view of a mounting structure of a first subsidiary lamp tube of the fluorescent lamp apparatus according to the embodiment of the present invention;

FIG. 5 is an exploded perspective view of a mounting structure of a second subsidiary lamp tube of the fluorescent lamp apparatus according to the embodiment of the present invention;

FIG. 6 is an exploded perspective view of a mounting structure of a first connection terminal of the fluorescent lamp apparatus according to the embodiment of the present invention;

FIG. 7 is an exploded perspective view of a mounting structure of a second connection terminal of the fluorescent lamp apparatus according to the embodiment of the present invention; and

FIG. 8 is a view illustrating usage of the fluorescent lamp apparatus according to one embodiment of the present invention.

### DETAILED DESCRIPTION OF THE INVENTION

Exemplary embodiments of the present invention will be described in detail with reference to the accompanying drawings hereinafter. Herein, a fluorescent lamp apparatus including a subsidiary lamp tube will be described as an example for convenience of description. The drawings may be exaggerated in thickness of lines or scale of components for the purpose of descriptive convenience and clarity only. Furthermore, terms used herein should be defined in consideration of functions of components of the present invention and thus can be changed according to the custom or intention of users or operators. Therefore, definition of such terms should be determined according to overall disclosures set forth herein.

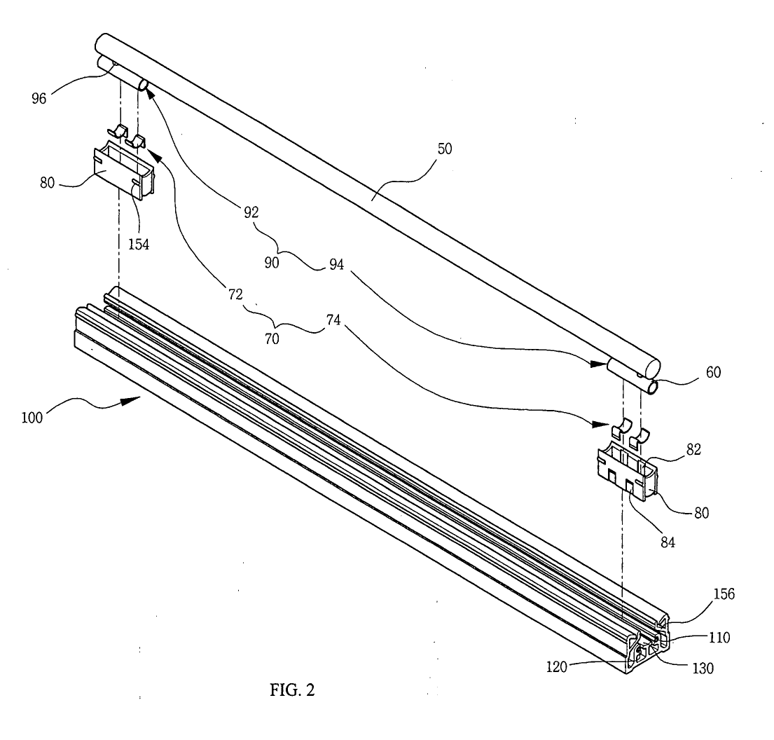

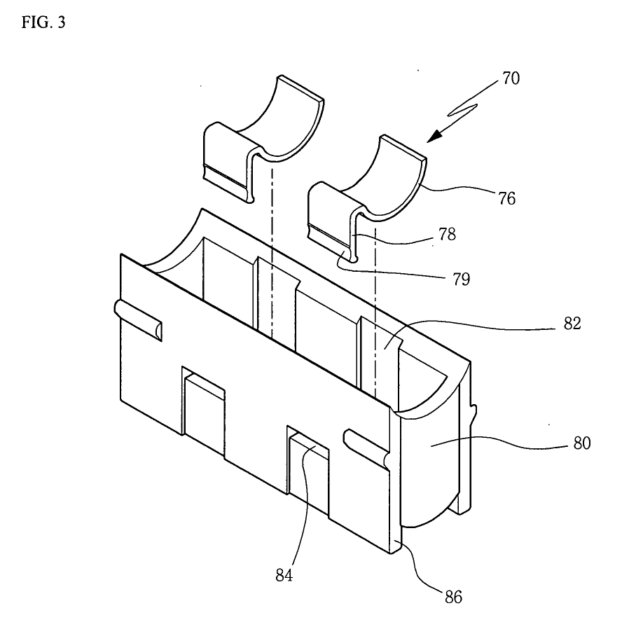

FIG. 2 is an exploded perspective view of a fluorescent lamp apparatus according to one embodiment of the invention, and FIG. 3 is an exploded perspective view of an insulation cap of the fluorescent lamp apparatus according to the embodiment of the invention.

Referring to FIGS. 2 and 3, the fluorescent lamp apparatus includes a main lamp tube 50 emitting light; a subsidiary lamp tube 90 disposed in communication with the main lamp tube 50; an external electrode 60 provided to the subsidiary lamp tube 90; a connection terminal 70 contacting the external electrode 60 to apply electric power to the external electrode 60; an insulation cap 80 receiving the connection terminal 70, and a base 100, on which the insulation cap 80 is detachably mounted, and in which first and second power supplies 110 and 120 are received. In this embodiment, the subsidiary lamp tube 90 is perpendicularly attached to the main lamp tube 50 while being disposed in parallel with the main lamp tube 50 in the longitudinal direction of the main lamp tube 50. It should be noted that the arrangement of the subsidiary lamp tube is not limited to this configuration and can be realized in various forms. For example, two or more subsidiary lamp tubes 90 may be disposed in different directions from each other, and may be disposed at a predetermined angle with respect to the longitudinal direction of the main lamp tube 50.

According to this embodiment, the subsidiary lamp tube 90 is disposed on one side of the main lamp tube 50, such that when the insulation cap 80 is coupled to the subsidiary lamp tube 90, the insulation cap 80 ensures contact between the external electrode 60 and the connection terminal 70. Therefore, when the insulation cap 80 having the subsidiary lamp tube 90 is coupled to the base 100, the first and second power supplies 110 and 120 are electrically connected to the connection terminal 70. In one implementation, the subsidiary lamp tube 90 is disposed on a lateral side of the main lamp tube 50. At this time, the subsidiary lamp tube 90 may be disposed in parallel with the main lamp tube 50. Alternatively, the subsidiary lamp tube 90 may be disposed at an angle with respect to an imaginary line extending from the main lamp tube.

The subsidiary lamp tube 90 includes a first subsidiary lamp tube 92 located at one side of the main lamp tube 50 and a second subsidiary lamp tube 94 at the other side. The first and second subsidiary lamp tubes 92 and 94 may be provided to opposite ends of the main lamp tube 50. Further, the first and second subsidiary lamp tubes 92 and 94 are symmetrically located on opposite ends of the main lamp tube 50 in this embodiment, but may be located at different positions thereon. The connection terminal 70 includes a connection terminal 72 that is provided to the first subsidiary lamp tube 92 to contact only the first power supply 110 and a connection terminal 72 that is provided to the second subsidiary lamp tube 94 to contact only the second power supply 120.

In the fluorescent lamp apparatus with such a configuration, electric discharge occurs inside the subsidiary lamp tubes 90 and/or the main lamp tube 50 so that light can be generated by means of a fluorescent material coated on an inner wall of the main lamp tube 50. Since the connection terminal 70 and the insulation cap 80 are provided to a peripheral surface of the subsidiary lamp tube 90 so as to correspond to the external electrode 60 located on the peripheral surface of the subsidiary lamp tube 90, the main lamp tube 50 located on the base 100 can emit not only from an intermediate section but also from both ends thereof. A connection tube 96 is interposed between the subsidiary lamp tube 90 and the main lamp tube 50. The external electrode 60 is formed of the same conductive material, for example metal, as that coated on the peripheral surface of the subsidiary lamp tube 90.

When electrical power is applied from the first and second power supplies 110 and 120 to the connection terminal 70 contacting the external electrode 60, a gas, with which the subsidiary lamp tube 90 is filled, is subjected to electric discharge by electric operation between the external electrode 60 and the connection terminal 70. Such electric discharge is transmitted into the main lamp tube 50 so that light is generated by the fluorescent material coated on the inner wall of the main lamp tube 50.

The connection terminal 70 includes the first connection terminal 72 contacting the first power supply 110 and the second connection terminal 74 contacting the second power supply 120. The first and second connection terminals 72 and 74 may be brought into contact with only the first and second power supplies 110 and 120, respectively. The connection terminal 70, i.e. each of the first and second connection terminals 72 and 74, includes a close contact part 76 contacting the external electrode 60, an extension part 78 extending from the close contact part 76; and a contact part 79 contacting only the first or second power supply 110, 120.

The insulation cap 80 includes an insertion part 82 to receive the first and second connection terminals 72 and 74; and a through-hole 84 formed on one side of the insertion part 82 such that the extension part 78 can be inserted into the through-hole 84. The insulation cap 80 may be made of a resilient material so as to permit easy insertion of the extension part 78.

The close contact part 76 has a downwardly concave surface and is inserted into the insertion part 82 of the insulation cap 80, so that the close contact part 76 is disposed on the bottom surface of the insulation cap 80. Then, the subsidiary lamp tube 90 is inserted into the insulation cap 80, so that the external electrode 60 on the peripheral surface of the subsidiary lamp tube 90 is brought into close contact with the connection terminal 70. At this time, the extension part 78 protrudes from the insulation cap 80 through the through-hole 84 and then comes into close contact with an outer wall of the insulation cap 80. When the insulation cap 80 is coupled to the base 100, the contact part 79 formed on the outer wall of the extension part 78 is brought into contact with the first and second power supplies 110 and 120 to supply electric power to the external electrode 60. Here, since the insulation cap 80 is detachably coupled to the subsidiary lamp tube 90, the main lamp tube 50 alone can be replaced by detaching the insulation cap 80 from the subsidiary lamp tube 90 when replacing the main lamp tube 50. Of course, the insulation cap 80 can be fixedly coupled to the subsidiary lamp tube 90.

Further, although both the first and second power supplies 110 and 120 can be DC power supplies, it is desirable that both be AC power supplies as in a typical fluorescent lamp apparatus.

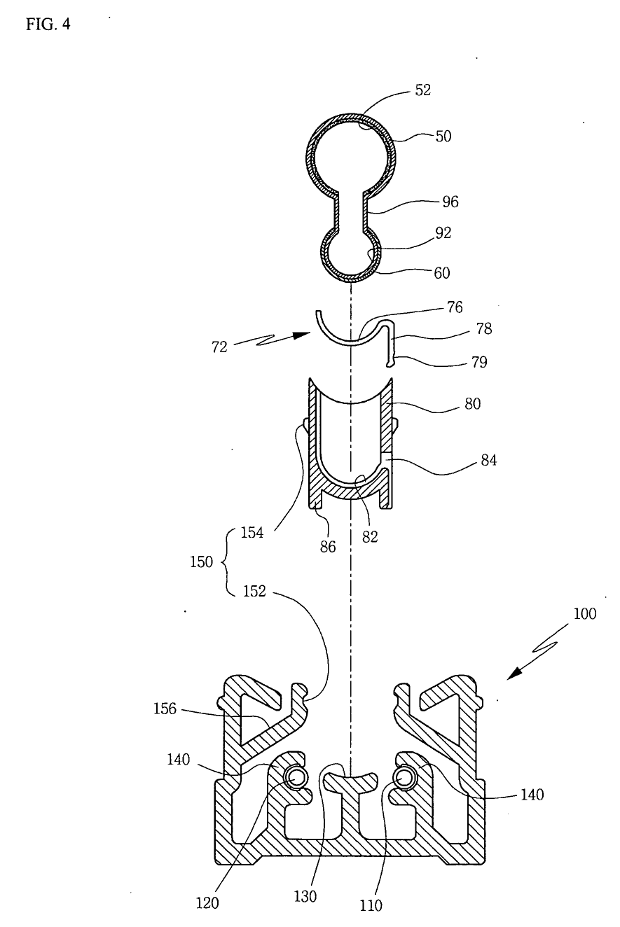

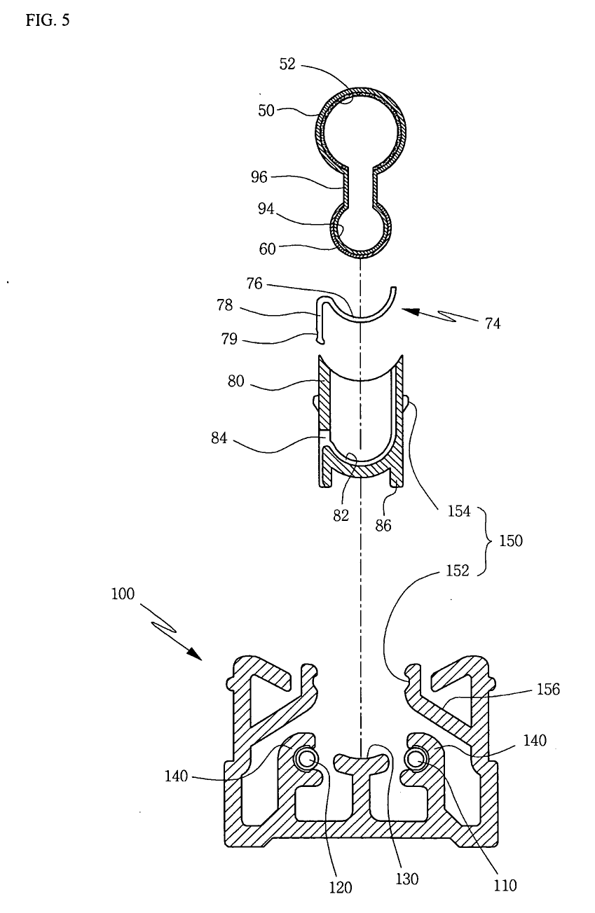

FIG. 4 is an exploded perspective view of a mounting structure of a first subsidiary lamp tube of the fluorescent lamp apparatus according to the embodiment of the present invention, and FIG. 5 is an exploded perspective view of a mounting structure of a second subsidiary lamp tube of the fluorescent lamp apparatus according to the embodiment of the present invention.

Referring to FIGS. 2, 4, and 5, the base 100 includes a seat 130 on which the insulation cap 80 is detachably mounted, a holding part 140 for holding the first and second power supplies 110 and 120, and a separation preventing part 150 which maintains contact between the connection terminal 70 and the first and second power supplies 110 and 120. The seat 130 is formed on the bottom of the base 100 so as to correspond to the insulation cap 80, and the holding part 140 is provided as a pair of holding parts which are separated a predetermined distance from opposite sides of the seat 130.

When the insulation cap 80 coupled to the main lamp tube 50 is inserted into the base 100, a lower end of the insulation cap 80 is positioned on top of the seat 130 and the extension part 78 of the connection terminal 70 is interposed between the seat 130 and the holding part 140. At this time, the first power supply 110 is inserted into one of the pair of holding parts 140, and the second power supply 120 is inserted into the other holding part 140, so that the connection terminal 70 can selectively contact the first power supply 110 and the second power supply 120 depending on a coupling direction of the insulation cap 80 to the base 100.

With the structural characteristics of the first and second power supplies 110 and 120 as described above, the first and second connection terminals 72 and 74 are alternately disposed at one side and the other side of the subsidiary lamp tube 90. When the main lamp tube 50 is coupled to the base 100 with the first and second subsidiary lamp tubes 92 and 94 coupled to the insulation caps 80, the first connection terminal 72 of the first subsidiary lamp tube 92 contacts the first power supply 110 and the second connection terminal 74 of the second subsidiary lamp tube 92 contacts the second power supply 120, so that electric power can be applied to the lamp tubes.

The separation preventing part 150 includes a resilient depression 152 formed at either side of the base 100 and a latch protrusion 154 formed on the insulation cap 80 to correspond to the resilient depression 152. The base 100 is elongated in a rail shape and has a groove formed along the center of the base 100 such that the main lamp tube 50 can be inserted into the groove. The resilient depression 512 is formed at either upper side above the groove.

When the insulation cap 80 is inserted into the groove of the base 100, an upper part of the base 100 is bent in opposite directions to allow the insulation cap 80 to be inserted into the groove of the base 100 through the bent upper part of the base 100. When the insulation cap 80 is completely inserted into the base 100, the base 100 returns to its original shape and the latch protrusions 154 are fitted into the resilient depressions 152, respectively. At this time, since the extension part 78 of the connection terminal 70 is located between the seat 130 and the holding part 140, the contact part 79 on the extension part 78 contacts the first and second power supplies 110 and 120, thereby enabling application of electric power.

With the configuration and operation as described above, the main lamp tube 50 can be easily connected to or disconnected from the base 100 by one-touch manner, thereby permitting easy installation and replacement of the main lamp tube 50.

Additionally, when the base 100 is longer than the main lamp tube 50, it is possible to consecutively dispose a plurality of main lamp tubes 50 in series in the base 100. Further, when the base 100 is formed in a variety of shapes, it is possible to provide various illumination effects by consecutively arranging a plurality of main lamp tubes 50 in one or more bases. At this time, the main lamp tubes 100 are arranged such that one end of the main lamp tube 50 is brought into contact with one end of another main lamp tube 50, whereby light emitting portions of the main lamp tubes 50 can become consecutive, thereby eliminating dark areas between the main lamp tubes 50 which are consecutively arranged.

In this embodiment, the fluorescent lamp apparatus includes a single main lamp tube 50 and two subsidiary lamp tubes 90. However, the present invention is not limited to this configuration. For example, when the external electrode 60 is disposed on the peripheral surface of the main lamp tube 50, the fluorescent lamp apparatus can be operated as in the above embodiment even when the subsidiary lamp tubes are omitted from the fluorescent lamp apparatus. In this case, with the connection terminal 70 and the insulation cap 80 directly coupled to the main lamp tube 50, the insulation cap 80 is inserted into the base 100, so that the fluorescent lamp apparatus can be operated as in the above embodiment.

Alternatively, the fluorescent lamp apparatus of the present invention may include a plurality of main lamp tubes 50. For example, two main lamp tubes 50 may be connected in parallel to communicate with each other via the connection tube 96, with the subsidiary lamp tube 90 coupled to each of the main lamp tubes 50.

Next, operation of the fluorescent lamp tube according to the embodiment of the present invention will be described.

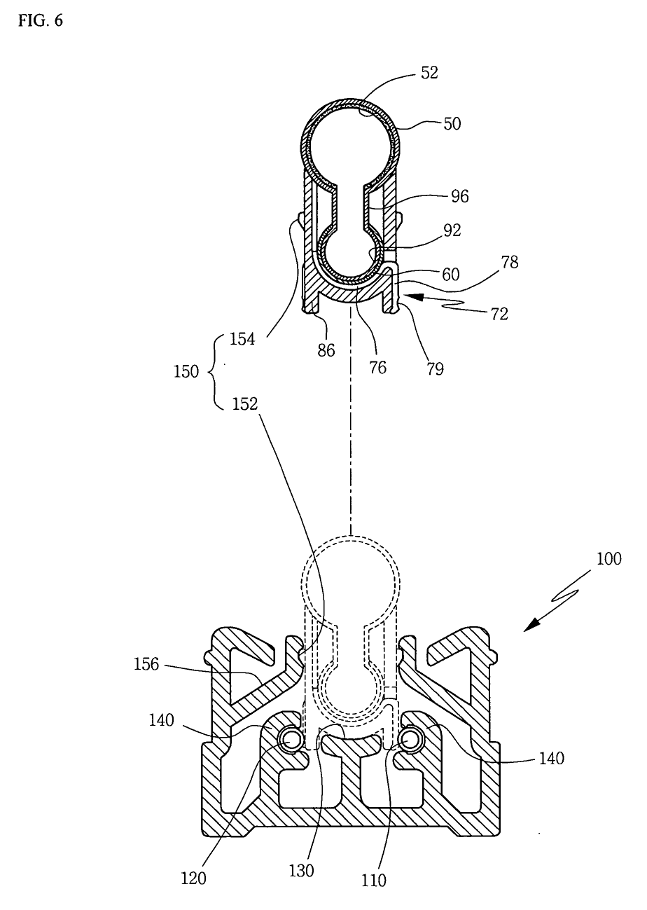

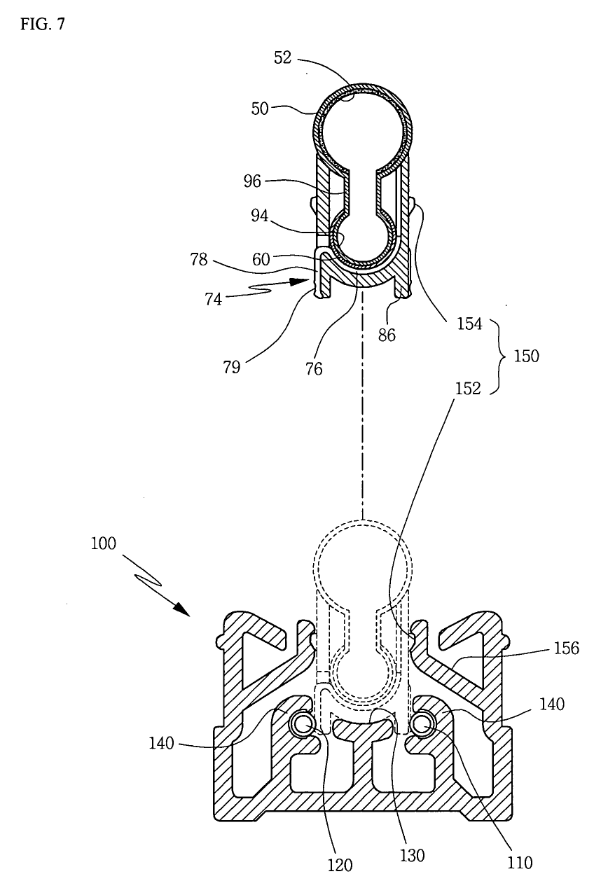

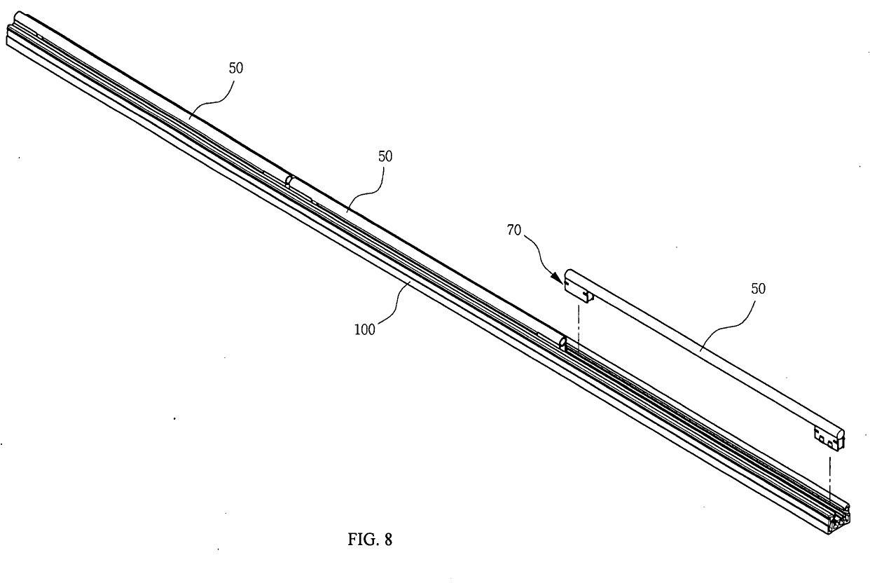

FIG. 6 is an exploded perspective view of a mounting structure of a first connection terminal of the fluorescent lamp apparatus according to the embodiment of the present invention, FIG. 7 is an exploded perspective view of a mounting structure of a second connection terminal of the fluorescent lamp apparatus according to the embodiment of the present invention, and FIG. 8 is a view illustrating usage of the fluorescent lamp apparatus according to one embodiment of the present invention.

Referring to FIGS. 6 to 8, first, the connection terminal 70 is inserted into the insulation cap 80. In this embodiment, since the insulation cap 80 is made of a resilient insulation material such as rubber, the through-hole 84 is deformed by a predetermined amount to allow the extension part 78 of the connection terminal 70 to protrude from the insulation cap 80 through the through-hole 84 with the close contact part 76 seated on the insertion part 82 of the insulation cap 80 when the connection terminal 70 is inserted into the insulation cap 80. Then, the subsidiary lamp tube 90 is coupled to the insulation cap 80 with the external electrode 60 contacting the close contact part 76 by inserting the insulation cap 80 into the subsidiary lamp tube 90. At this time, the extension part 78 of the first connection terminal 72 is disposed at one side of the first subsidiary lamp tube 92, and the extension part 78 of the second connection terminal 74 is disposed at the other side of the second subsidiary lamp tube 94. Next, the insulation cap 80 coupled to the main lamp tube 50 is inserted into the base 100. At this time, resilient pieces 156 each having the resilient depression 152 are deformed by a predetermined amount in opposite directions to allow the insulation cap 80 to be inserted into the center of the base 100. When the insulation cap 80 is completely inserted into the base 100, the resilient pieces 157 return to their original shape and the latch protrusions 154 are fitted into the resilient grooves 152, thereby preventing separation of the insulation cap 80. Here, since the insulation cap 80 has seating legs 86 protruding downward from opposite lower ends of the insulation cap 80, the seating legs 86 restrict opposite sides of the seat 130 to prevent movement of the insulation cap 80 when the insulation cap 80 is brought into contact with the seat 130.

When coupling between the insulation cap 80 and the base 100 is completed, the extension part 78 of the connection terminal 70 is located between the seat 130 and the holding part 140 to contact the first and second power supplies 110 and 120 received in the holding part 140 so that electric power can be supplied to the external electrode through the connection terminal 70. Then, the electric power applied to the external electrode 60 through the connection terminal 90 causes electric discharge of a gas, with which the subsidiary lamp tube 90 and the main lamp tube 50 are filled, so that a fluorescent material 52 coated on the inner wall of the main lamp tube 50 is activated to emit light.

Further, a plurality of main lamp tubes 50 can be provided to a single base by repeating the aforementioned operation several times. As such, when the plurality of main lamp tubes 50 are consecutively arranged in the fluorescent lamp apparatus, one end of one main lamp tube 50 contacts the other end of another main lamp tube 50 such that light emitting parts of the lamp tubes 50 can be consecutively arranged. Therefore, according to this embodiment, even when a number of main lamp tubes 50 are consecutively arranged, no dark areas are present between the main lamp tubes 50.

When replacing the main lamp tube 50, the main lamp tube 50 is pulled from the base 100. As a result, the resilient pieces 156 are deformed by a predetermined amount in opposite directions to allow the latch protrusions 154 to be released from the resilient grooves 154, enabling convenient replacement of the main lamp tube 50.

As apparent from the above description, in the fluorescent lamp apparatus according to the present invention, a connection terminal and an insulation cap are provided to a subsidiary lamp tube which communicates with a main lamp tube, so that a plurality of main tube lamps can be consecutively arranged with light emitting parts of the main lamp tubes consecutively arranged, thereby preventing dark areas between the main lamp tubes. Further, according to the present invention, the fluorescent lamp apparatus has external electrodes on the subsidiary lamp tube, thereby permitting various pleasant shapes and arrangements of lighting devices.

Further, according to the present invention, the fluorescent lamp apparatus has the connection terminal and the insulation cap disposed at one side of the main lamp tube while allowing the insulation cap to be detachably coupled to a base by one-touch manner to permit easy installation and separation of the fluorescent lamp, thereby reducing both time and cost for installation and replacement of the fluorescent lamp.

Although the present invention has been described with reference to the embodiments and the accompanying drawings, the embodiments and drawings are given by way of illustration only, and, it will be apparent to those skilled in the art that various modifications and equivalent other embodiments can be made without departing from the scope of the present invention. In addition, although the present invention has been described with reference to the fluorescent lamp apparatus including a main lamp tube and a subsidiary lamp tube as specifically disclosed herein, it should be noted that such a fluorescent lamp apparatus has been given for illustration only and can be modified into various forms. Therefore, the scope and spirit of the invention is limited only by the claims set forth herein as follows.

What is claimed is:

1. A fluorescent lamp apparatus comprising:
a main lamp tube emitting light;
a subsidiary lamp tube disposed in communication with the main lamp tube;
an external electrode provided to the subsidiary lamp tube;
a connection terminal contacting the external electrode such that electric power is applied to the external electrode through the connection terminal; and
an insulation cap receiving the connection terminal.

2. The fluorescent lamp apparatus according to claim 1, wherein the connection terminal comprises a first connection terminal contacting only a first power supply and a second connection terminal contacting only a second power supply.

3. The fluorescent lamp apparatus according to claim 2, wherein each of the first and second connection terminals comprises a close contact part contacting the external electrode; an extension part extending from the close contact part; and a contact part contacting only the first and second power supplies.

4. The fluorescent lamp apparatus according to claim 3, wherein the insulation cap comprises an insertion part receiving the first and second connection terminals; and a through-hole formed on one side of the insertion part such that the extension part is fitted into the through-hole.

5. The fluorescent lamp apparatus according to claim 4, further comprising:
a base on which the insulation cap is detachably mounted, the base having the first and second power supplies.

6. The fluorescent lamp apparatus according to claim 2, further comprising:
a base on which the insulation cap is detachably mounted, the base having the first and second power supplies.

7. The fluorescent lamp apparatus according to claim 6, wherein the base comprises:
a seat on which the insulation cap is detachably mounted;
a holding part holding the first and second power supplies; and
a separation preventing part maintaining contact between the connection terminal and the first and second power supplies, the separation preventing part comprising a resilient depression formed on either side of the base and a latch protrusion formed on the insulation cap.

8. The fluorescent lamp apparatus according to claim 1, wherein the subsidiary lamp tube is disposed at a lateral side of the main lamp tube.

9. The fluorescent lamp apparatus according to claim 8, wherein the subsidiary lamp tube is disposed in parallel with the main lamp tube.

10. The fluorescent lamp apparatus according to claim 9, wherein the subsidiary lamp tube is disposed at an angle with respect to an imaginary line extending from the main lamp tube.
